(19) United States
(12) Patent Application Publication
(10) Pub. No.: US 2008/0061149 A1
(43) Pub. Date: Mar. 13, 2008

(54) Proximity payment card with security interlock

(76) Inventor: Colin Tanner, Uxbridge (GB)

Correspondence Address: BUCKLEY, MASCHOFF & TALWALKAR LLC, 50 LOCUST AVENUE, NEW CANAAN, CT, 06840, US

(21) Appl. No.: 11/518,754

(22) Filed: Sep. 11, 2006

(51) Int. Cl. G06K 19/06

(52) U.S. Cl. 235/492

(57) ABSTRACT

An identification token includes a body and a radio frequency identification (RFID) integrated circuit (IC) supported by the body. A light sensor is coupled to the RFID IC. The RFID IC is operative to transmit an identification code in response to an interrogation signal only if the light sensor is detecting ambient light.

### BACKGROUND

It has been proposed (e.g., in U.S. Pat. No. 6,863,220) to include a user-actuated switch in a proximity payment card so that the card may be in an unactivated state except when the user actuates the switch while presenting the card for reading by a point of sale terminal. By requiring a user to actuate a switch in order to activate the card, it may be possible to prevent certain attacks on the security of the card account number. Such attacks may occur by surreptitiously reading the card from a distance while the card is in the holder's purse or wallet.

A possible disadvantage of proposed designs for a proximity payment card having a user-actuatable switch is that the manufacturing cost of the card may be increased by incorporating a switch in the card. Also, some users may prefer not to have to actuate a switch while presenting their cards for reading.

### BRIEF DESCRIPTION OF THE DRAWINGS

FIG. 1 is a schematic plan view of a proximity payment card according to some embodiments.

FIG. 2 is a view of a simplified example of the front surface of the card of FIG. 1.

FIG. 3 is a flow chart that illustrates a process that may be performed by a radio frequency identification (RFID) integrated circuit (IC) that is included in the card of FIGS. 1 and 2.

FIG. 4 is a block diagram representation that illustrates use of the payment card of FIGS. 1 and 2 according to aspects of the present invention.

FIG. 5 is a simplified block diagram of a point of sale terminal provided according to other aspects of the present invention.

### DETAILED DESCRIPTION

In general, and for the purpose of introducing concepts of embodiments of the present invention, a proximity payment card includes a light sensor coupled to the RFID IC of the card. Unless the proximity payment card is exposed to ambient light that is detected by the light sensor, the RFID IC is disabled from transmitting any payment card account number that is stored in the RFID IC. In this way, the proximity payment card may be protected from surreptitious reading while the card is in the cardholder's wallet or handbag.

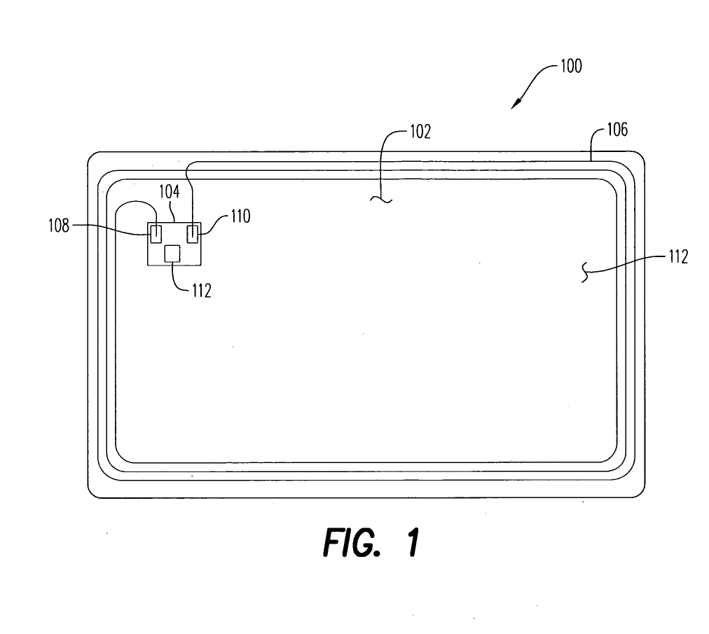

FIG. 1 is a schematic plan view of a proximity payment card 100 according to some embodiments. The proximity payment card 100 may include a card-shaped body 102, which may resemble conventional payment cards in shape and size. The card-shaped body 102 may be formed of plastic or another suitable material.

The proximity payment card 100 may also include an RFID IC 104. The RFID IC 104 may be mounted and/or installed in any suitable manner in the card-shaped body 102. For example, the RFID IC 104 may be embedded (partially or completely) in the card-shaped body 102. The RFID IC 104 may be suitably designed and configured to transmit payment card account information by radio frequency signaling to a POS terminal. In general, the RFID IC 104 may be designed and configured to operate in accordance with the “PayPass” standard promulgated by MasterCard International Incorporated, the assignee hereof.

The proximity payment card 100 may further include an antenna 106 embedded in or otherwise mounted on the card-shaped body 102. As shown, the antenna 106 may be in the form of several loops arranged along the periphery of the card-shaped body. Alternatively, the antenna 106 may be of a different type and/or configuration. The antenna may be operative generally in accordance with the above-mentioned PayPass standard to receive interrogation and power signals (which may be the same signal) from a proximity coupling device of a POS terminal and to transmit payment card account number information and/or other information to the proximity coupling device. The antenna 106 may be coupled to the RFID IC 104 via terminals 108, 110, each coupled to a respective end of the antenna 106.

In accordance with some embodiments of the invention, the proximity payment card 100 may also include a light sensor 112 that is coupled to the RFID 104. (In addition, or alternatively, the light sensor 112 may be coupled to the antenna 106.) In the particular example embodiment illustrated in FIG. 1, the light sensor 112 is physically supported on the RFID IC 104, although other mounting arrangements may alternatively be employed. The light sensor 112 may be any type of device that outputs a signal in response to being exposed to light or other radiation or changes an electrical characteristic in response to being exposed to light or other radiation. For example, the light sensor 112 may take the form of a photodiode or a photocell, either of which may be formed directly on a surface of the RFID IC 104 and may be coupled by a suitable signal path or paths (not separately shown) to the integrated circuitry (not separately shown) of the RFID IC 104.

In some embodiments, lettering (not shown in FIG. 1) or other symbols (not shown in FIG. 1) may be present on the front surface 122 of the card-shaped body 102 and/or on the rear surface (not shown) of the card-shaped body 102. The proximity payment card 100 may have one or more magnetic stripes (not shown) on the card-shaped body 102 to allow the proximity payment card 100 to be read by a magnetic card reader. In addition, or alternatively, there may be embossed numbers and/or letters on the card-shaped body to indicate one or more account numbers and/or the name of the holder of the proximity payment card 100. In addition, or alternatively, non-embossed printing on the front surface 122 may indicate the account numbers and/or the holder's name. Still further, the front surface 122 of the card-shaped body 102 may carry one or more logos and/or brands, including for example the brand/logo of a national payment card association such as MasterCard International Incorporated. The brand/logo of the issuer may also be present, as well as, for example, a specific card product brand. Other conventional features that may be present on the proximity payment card 100 (though such features are not shown) are an adhesive paper strip to receive the signature of the cardholder, and a security code or the like printed on the adhesive strip.

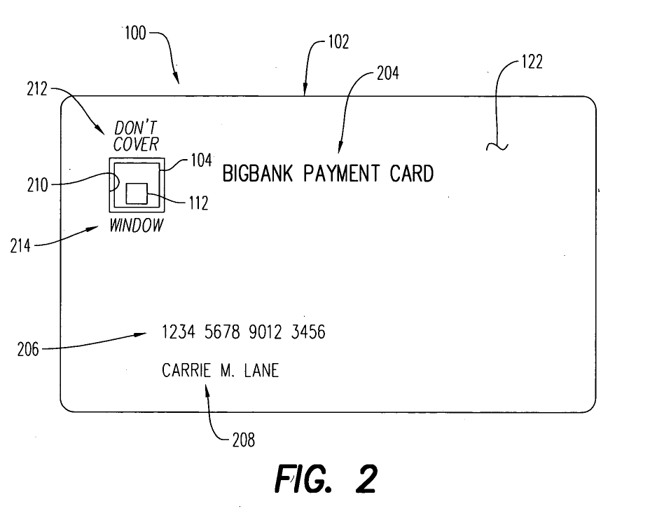

FIG. 2 presents the visual appearance of a simplified example of the front surface 122 of the proximity payment card 100. There may be printed information on the front surface 122, such as the brand name and/or name of the issuer for the payment card, as indicated at 204. The printed information may further include a visual representation 206 of the payment card account number stored in the RFID IC 104, and the cardholder's name 208. In addition, and in accordance with embodiments of the invention, a window 210 is formed in the front surface 122 of the card body 102 at the locus of the RFID IC 104 and the light sensor 112 to allow ambient light to reach the light sensor 112. The window 210 may be formed of a clear plastic inset (not separately shown) in the front surface 122, it being assumed for present purposes that the card body 102 is otherwise formed of opaque plastic or the like.

The printed information on the front surface may also include an indication shown at 212, 214 to indicate to the user that the user is to keep his/her fingers away from the window. But for this indication, it may be somewhat likely that the user may occasionally obscure the window while presenting the proximity payment card 100 for reading, thereby preventing ambient light from reaching the light sensor 112 so that the card would be unintentionally disabled.

In accordance with other embodiments, the card body 102 may be largely or at least partially formed of transparent and/or translucent plastic, at least in the region of the RFID IC 104/light sensor 112, so that the light sensor is readily exposed to ambient light while the card 100 is in use. In such a case, a localized window may not be required. It may nevertheless still be desirable to include an indication by printed information or the like to warn the user not to obscure the light sensor while presenting the card for reading by a proximity coupling device. In some embodiments, the light sensor may face the rear surface (not shown) of the card, and the window may be formed in the rear surface rather than the front surface.

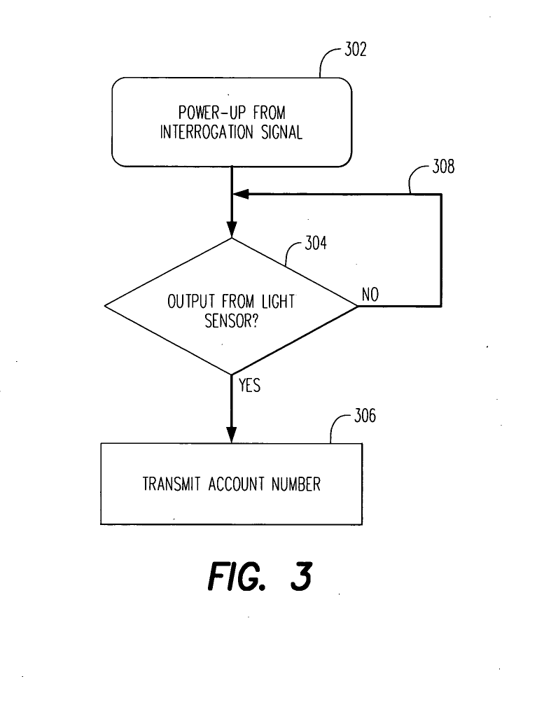

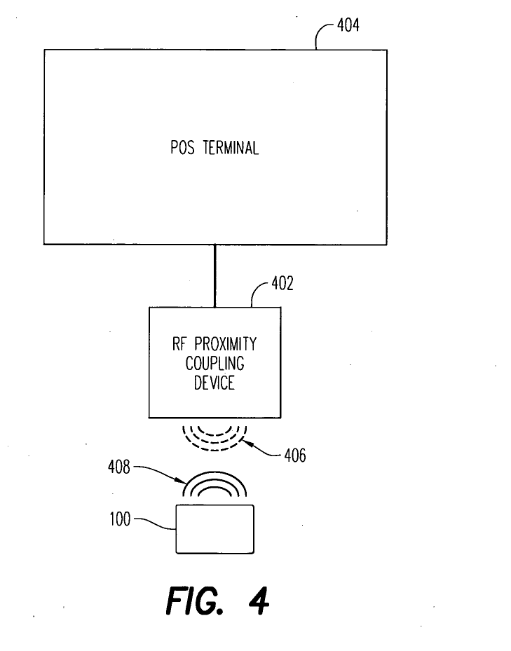

FIG. 3 is a flow chart that illustrates a process that may be performed by the RFID IC 104 and thus also illustrates aspects of operation of the proximity payment card 100. FIG. 4 is a block diagram representation that illustrates use of the payment card 100 according to aspects of the present invention.

In operation, the user presents the proximity payment card 100 to a proximity coupling device 402 (FIG. 4) which is interfaced to a point of sale terminal 404. The proximity coupling device 402 transmits an interrogation signal 406. The proximity payment card 100 receives the interrogation signal via the antenna 106 (FIG. 1), causing the RFID IC 104 to be powered-up—as indicated at 302 in FIG. 3—in a conventional manner (e.g., by rectifying the received interrogation signal to generate a DC power level).

At 304 in FIG. 3, the RFID IC 104 determines whether it is receiving an output signal from the light sensor 112 to indicate that the light sensor is currently exposed to ambient light (or if an electrical characteristic currently exhibited by the light sensor indicates that the light sensor is currently exposed to ambient light). If so, then the RFID IC 104 may transmit (306 in FIG. 3, 408 in FIG. 4) a signal to proximity coupling device 402 in response to the interrogation signal 406. The signal transmitted by the RFID IC 104 may include a payment card account number that was previously stored in the RFID IC 104 and/or other information required for interaction with the proximity coupling device 402. The RFID IC 104 may transmit the signal (and possibly one or more additional signals) to the proximity coupling device 402 via the card's antenna 106.

Considering again the determination made at 304 (FIG. 3), if the RFID IC 104 determines that it is not receiving an output signal from the light sensor 112 to indicate that the light sensor is currently exposed to ambient light, then the RFID IC 104 may idle, as indicated at 308, without transmitting the payment card account number or any other information. Consequently, if the payment card were being subjected to an attack in which the card, while in the cardholder's wallet or hand bag, was being surreptitiously interrogated by a malefactor, the card would not respond to the interrogation signal since the light sensor would interlock the RFID IC from responding when the light sensor is not exposed to light.

The determination made at 304 may, instead of considering whether there is any output from the light source, alternatively consider whether the level of an output from the light source exceeds a threshold level.

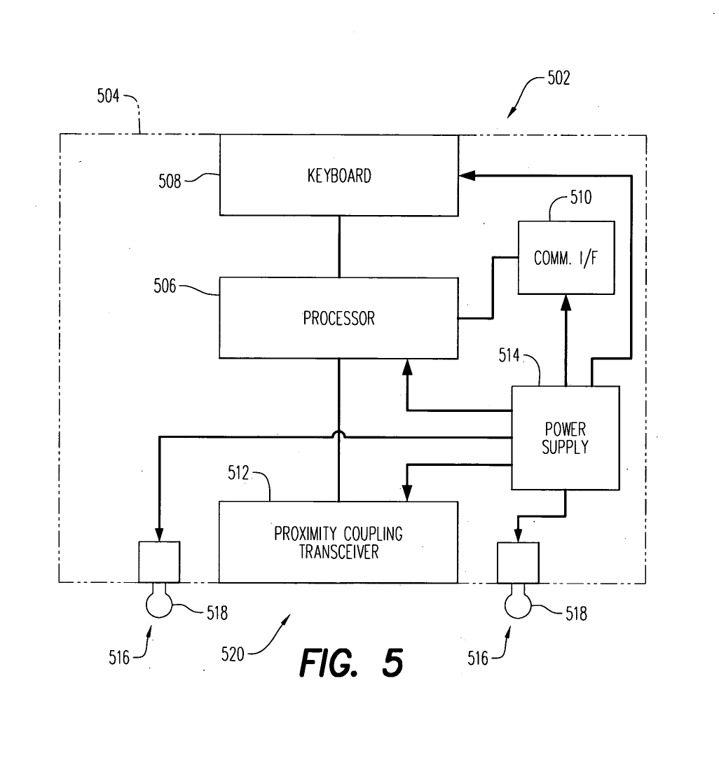

One issue that may need to be addressed in connection with the proximity payment card disclosed herein is that some POS terminals may be situated in rooms (e.g., in restaurants or bars) that are not well-lit, so that the general light level may be too low for the light sensor to detect. To deal with this type of situation, there may be provided, in accordance with aspects of the present invention, a POS terminal that includes a light source to illuminate proximity payment cards presented for reading by the POS terminal. An example of such a POS terminal is indicated generally by reference numeral 502 in FIG. 5.

The POS terminal 502 shown in FIG. 5 includes a housing 504 (indicated as a dotted line perimeter) which may include most or all of the hereinafter described components of the POS terminal. The components in the housing 504 may include a processor 506, which may be a conventional microprocessor to control over-all operation of the POS terminal 502. Although not shown, one or more memory devices may be included in the POS terminal 502 and associated with the processor 506 to store firmware and/or software instructions to control the processor 506 and also to serve as working memory. In addition, the POS terminal 502 may include a conventional keyboard 508 or other input device (e.g., a barcode reader), coupled to the processor 506, by which information concerning transactions (e.g., purchases) may be input to the processor 506. There may be one or more other input/output devices included in the POS terminal and coupled to the processor 506, although such other devices are not shown in the drawing. Further, the POS terminal 502 may include a communications interface 510, coupled to the processor 506, by which the processor 506 may exchange data communications with external devices (not shown), such as payment card authorization servers from which the processor 506 may obtain authorizations for payment card transactions.

Still further, the POS terminal 502 may include a module 512 which is coupled to the processor 506 and functions as a proximity coupling device to interrogate and read account number data from proximity payment cards. Although shown as within the same housing 504 with the processor, the proximity coupling module may alternatively be housed in a separate housing from the processor and may be coupled to the POS terminal proper and/or the processor 506 by suitable cabling.

Also included in the POS terminal 502 is a conventional power supply 514 which supplies power signals to the electrical and electronic components of the POS terminal 502. (If the proximity coupling device is in a separate housing from the processor, there may be an additional power supply in the separate housing for supplying power to the proximity coupling device.) As used herein and in the appended claims, the term power supply encompasses any subordinate supplies needed to step up or down a power voltage signal as required by various components of the POS terminal.

In accordance with aspects of the invention, the POS terminal may include one or more light sources 516 mounted in or on the housing 504 (and/or on the separate housing for the proximity coupling device, if a separate housing is present). Each of the light sources 516 may include a light bulb 518, a light-emitting diode or diodes or other light-emitting device. Each light source 516 is coupled to the power supply 514 to receive power therefrom. The light source(s) is (are) positioned to illuminate a space 520 that is adjacent the proximity coupling device 512 so that there is ample ambient light in the space 520 to be detected by a light sensor component of a proximity payment card presented for reading by the proximity coupling device 512. (The number of light sources may be any number of one or more.)

As used herein and in the appended claims, the term “ambient light” refers to any light or other radiation that impinges on the light sensor and is not limited to light from the sun or room lighting fixtures. For example, “ambient light” encompasses light or other radiation emitted at a POS terminal at a selected wavelength to which the light sensor is sensitive. “Ambient light” thus may encompass UV radiation.

Embodiments of some aspects of the invention have heretofore been described with reference to a card-shaped proximity payment device, but the teachings disclosed herein are also applicable to proximity payment devices which are not card-shaped. As used herein and in the appended claims, “proximity payment device” refers to any device, whether or not card shaped, which transmits to a point of sale terminal, by wireless transmission, a payment account number.

Although not indicated in the drawings, one or more of the proximity payment devices may have a contact interface like that of a conventional smart card that includes a contact interface.

The principles taught herein have heretofore been described in the context of proximity payment devices. Nevertheless, these teachings are also applicable to cards or the like issued by transportation systems (e.g., mass transit systems) for access to the transportation systems; to cards used to identify the holder for purposes apart from or in addition to transaction payments; and to so-called electronic passports (also known as RFID-enabled passports). As used herein and in the appended claims the term “identification token” refers to an object that serves as one or more of a proximity payment device, a transportation card, an identification card and/or an RFID-enabled passport. The term “transportation card” refers to a card or similar device used to pay, or confirm or evidence payment of, a charge for using a transportation system. The term “RFID-enabled passport” refers to an internationally recognized travel document that includes an IC and an antenna and communicates with a terminal by a wireless communication technique.

The window 210 is shown in FIG. 2 as being larger by a small amount than the RFID IC 104, but in other embodiments the window may be larger or smaller than as shown. For example, in some embodiments, the window may be smaller than the RFID IC 104 and about the same size or slightly larger than the light sensor 112.

As an alternative to forming the light sensor directly on the RFID IC, the light sensor may be incorporated in a module with the RFID IC. Such a module may include a module body that supports the RFID IC and the light sensor. The module may be suitably embedded in or otherwise incorporated in the card body during manufacture of the card.

In some embodiments the light sensor may be effectively employed as a source of user input signals to the RFID IC by selectively covering and uncovering (e.g., with the cardholder's finger) the light sensor according to a pattern of actions over time that the RFID IC is programmed to detect and/or respond to.

In some embodiments, the material of which the body of the card is formed may be opaque in appearance while being translucent only to a certain wavelength or wavelengths of light or other radiation to be detected by the light sensor. The light sensor may be tuned to detect only that (those) wavelength(s), which may be or include UV radiation. It may not be necessary to provide a window in the card body if, e.g., the card body is translucent to radiation to be detected by the light sensor. The light sensor may be such that it detects radiation only in a relatively narrow wavelength band having a bandwidth of about 150 nm or less.

The above description and/or the accompanying drawings are not meant to imply a fixed order or sequence of steps for any process referred to herein; rather any process may be performed in any order that is practicable, including but not limited to simultaneous performance of steps indicated as sequential.

As used herein and in the appended claims, the term “embedded” includes both completely and partially embedded.

As used herein and in the appended claims, the term “identification code” refers to a payment card account number or any other number or code that is stored in and transmitted by the RFID IC of an identification token.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. An identification token comprising:
a body;
a radio frequency identification (RFID) integrated circuit (IC) supported by the body; and
a light sensor coupled to the RFID IC;
wherein the RFID IC is operative to transmit an identification code in response to an interrogation signal only if the light sensor is detecting ambient light.

2. The identification token of claim 1, wherein the light sensor is supported on the RFID IC.

3. The identification token of claim 1, wherein the identification code is a payment card account number.

4. The identification token of claim 1, further comprising:
an antenna embedded in the body and coupled to the RFID IC;
and wherein the RFID IC receives the interrogation signal via the antenna.

5. The identification token of claim 4, wherein the interrogation signal provides power for operation of the RFID IC.

6. The identification token of claim 5, wherein the body is card-shaped.

7. The identification token of claim 1, wherein the RFID IC does not receive a power signal from the light sensor.

8. The identification token of claim 1, wherein the body is card-shaped.

9. The identification token of claim 8, further comprising:
a window in said body at a locus of the light sensor, said window for allowing ambient light to reach the light sensor.

10. The identification token of claim 9, further comprising:
an indication on said body for indicating to a user that the user is to keep the user's fingers from covering said window.

11. The identification token of claim 1, wherein the light sensor is tuned to detect radiation only in a wavelength band that does not exceed about 150 nm in width.

12. A method comprising:
receiving an interrogation signal at a radio frequency identification (RFID) integrated circuit (IC);
determining whether a light sensor coupled to the RFID IC is detecting ambient light; and
transmitting an identification code from the RFID IC if it is determined that the light sensor is detecting ambient light.

13. The method of claim 12, wherein the receiving step includes powering the RFID IC from the interrogation signal.

14. The method of claim 12, wherein the identification code is a payment card account number.

15. The method of claim 12, wherein the receiving step includes receiving the interrogation signal via an antenna embedded in a card-shaped body.

16. The method of claim 15, wherein the transmitting step includes transmitting the identification code via the antenna.

17. The method of claim 16, wherein the receiving step includes powering the RFID IC from the interrogation signal.

18. The method of claim 17, wherein the RFID IC does not receive a power signal from the light sensor.

19. A point of sale (POS) terminal comprising:
a processor;
input means, coupled to the processor, for receiving transaction information;
a proximity coupling device, coupled to the processor, for receiving payment card account information from a proximity payment device;
a housing that contains at least one of the proximity coupling device and the processor;
a power supply contained in the housing; and
a light source positioned to illuminate a space adjacent the proximity coupling device, the light source coupled to the power supply to receive power from the power supply.

20. The POS terminal of claim 19, wherein the light source is mounted on the housing.

21. The POS terminal of claim 20, wherein the light source comprises a light-emitting diode.
